(19) United States
(12) Patent Application Publication
(10) Pub. No.: US 2009/0031878 A1
(43) Pub. Date: Feb. 5, 2009

(54) Pick for playing a non-bowed stringed instrument

(76) Inventor: Richard Ouellette, Moncton (CA)

Correspondence Address: RICHARD OUELLETTE, 14 Firwood Crescent, Moncton, NB, E1A 5X2, CA

(21) Appl. No.: 11/788,846

(22) Filed: Apr. 23, 2007

(51) Int. Cl. G10D 3/16

(52) U.S. Cl. 84/322

(57) ABSTRACT

A pick for playing a non-bowed stringed instrument, such as a guitar, comprises a main body having a front surface and a back surface, and a peripheral edge adjoining the front surface and a back surface. At least a substantial portion of the main body comprises a doming mixture. The pick is formed by providing a thin flat backing having a front face and a back face; placing the thin flat backing onto a curing tray with the back face against the curing tray and the font face facing generally upwardly; introducing a doming mixture onto the front face of the thin flat backing; permitting the doming mixture to cure, thus forming a hardened resin mixture pick having a bottom surface and a domed top surface; and separating the thin flat backing from the hardened pick.

### FIELD OF THE INVENTION

The present invention relates to guitar picks, and more particularly to guitar picks made from an epoxy, polyurethane or other liquid resin mixtures and materials, which harden to predetermined customizable shapes.

### BACKGROUND OF THE INVENTION

Stringed musical instruments are instruments in which sound is produced by the vibrations of one or more taut strings that are strung over most of the length of the musical instrument. The vibrations are produced either by drawing a bow across the strings, or in the case of some types of non-bowed stringed musical instruments, such as the guitar, banjo, ukulele, harp, dulcimer, and so on, are produced by either ones fingertips, or preferably by a pick, plectrum, or the like, held by ones fingers and thumb. The pick is drawn across one or more of the strings of the musical instrument at a time, in a plucking or strumming manner to play music.

Typically, conventional picks for stringed musical instruments are made from resilient plastic material with a smooth surface. Although these conventional picks have been around for a number of years, and are generally thought to work quite well, there are a number of drawbacks with these conventional picks for stringed musical instruments, and specifically for the guitar, which is the most commonly played of these types of stringed musical instruments. Accordingly, for the sake of ease of reference, guitar picks will be generally focussed on in this background.

The most significant drawback is that such picks do not conform to the finger position of the guitarist. Accordingly, known prior art guitar picks are not as comfortable as they might otherwise be.

Further, not all shapes are possible with present conventional picks. Most guitar picks are generally triangularly shaped, with a few other shapes possible, that can be readily formed by using standard guitar pick manufacturing techniques. These picks require expensive dies or molds to attain the desired size and shape of guitar pick, which is often cost prohibitive to small production runs of custom shape guitar picks.

Additionally, it is difficult to print full color photographic quality pictures on conventional plastic picks. Most conventional picks are made from colorful plastic material, and are of one or more colors. Often, such guitar picks have a single color design printed thereon. It is not known in the prior art to produce guitar picks having full color photographic quality pictures on them.

Further, it is difficult to produce a completely transparent pick by utilizing the standard guitar pick manufacturing products presently available, either as an entire pick, or with photograph, or similar, within the guitar pick such that the photograph is readily viewable. Having a viewable photograph, or similar, within the guitar pick, is highly desirable as it would allow for the production guitar picks having pictures of favourite musicians or groups, or alternatively other subject matter such as logos of sports teams or pictures of professional athletes, and so on.

The closest known prior art guitar pick is taught in U.S. Pat. No. 7,179,976 issued Feb. 20, 2007 to West, which discloses a Fingernail Pick for Stringed Instruments that is removably attachable to a user's fingernail. In that patent, at column 7, in the paragraph beginning at line 39, it is stated with reference to FIG. 11, that “ . . . the replaceable playing surface 11 allows for the interchange of different types of playing surfaces. For example, playing surfaces made from different materials could be used to change the volume, tone or timbre of the instrument. Examples of different materials that could be used as the playing surface 11 include, but are not limited to, various plastics, thermoplastics, glass, graphite, ceramics, fiberglass, resin, animal products, plant material, metal, wood or stone.” In that patent, it is referred to only obliquely that resins could be used to form a fingernail pick. It does not specifically teach that guitar picks can be made from epoxy resin.

There are also two other prior art documents that are only somewhat related.

United States Published Patent Application No. 2004/0031372 published Feb. 19, 2004 to Glyde discloses a Floating Blade Plectrum wherein the blade 1 has a cloth attachment 2 secured to the blade 1 using epoxy resin.

U.S. Pat. No. 4,248,128 issued Feb. 3, 1981 to Des Gaines discloses a Guitar Pick Array having a base 13 that is made from epoxy. The actual guitar picks are not made from epoxy resin.

It is an object of the present invention to provide guitar picks made from a doming mixture.

It is another object of the present invention to provide guitar picks made from a doming mixture, which guitar picks conform to the finger position of the guitarist.

It is another object of the present invention to provide guitar picks made from a doming mixture, which guitar picks are comfortable.

It is a further object of the present invention to provide guitar picks made from a doming mixture, which guitar picks are either common triangular shapes or customized shapes.

It is a further object of the present invention to provide guitar picks made from a doming mixture, wherein it is not cost prohibitive to produce small production runs of custom shape guitar picks.

It is a further object of the present invention to provide guitar picks made from a doming mixture, which guitar picks have from one colour to full colour photographic quality pictures on them.

It is a further object of the present invention to provide guitar picks made from a doming mixture, which guitar picks are partially to completely transparent

It is a further object of the present invention to provide guitar picks made from a doming mixture, which guitar picks are partially to completely printed.

It is a further object of the present invention to provide guitar picks made from a doming mixture, which guitar picks provide a softer and superior tone not available with conventionally manufactured picks and only comparable to picks made with tortoise shells picks, which are presently considered illegal for tortoise preservation reasons.

### SUMMARY OF THE INVENTION

In accordance with one aspect of the present invention there is disclosed a novel pick for playing a non-bowed stringed instrument, such as a guitar. The guitar pick comprises a main body having a front surface and a back surface, and a peripheral edge adjoining the front surface and a back surface. At least a substantial portion of the main body comprises a doming mixture.

In accordance with another aspect of the present invention there is disclosed a novel method of forming a pick for playing a non-bowed stringed instrument, such as a guitar, the method comprising the steps of providing a thin flat backing having a front face and a back face; placing the thin flat backing onto a curing tray with the back face against the curing tray and the font face facing generally upwardly; introducing a doming mixture onto the front face of the thin flat backing; permitting the doming mixture to cure, thus forming a hardened resin mixture pick having a bottom surface and a domed top surface; and separating the thin flat backing from the hardened pick.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the guitar pick according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the first preferred embodiment of the guitar pick according to the present invention;

FIG. 2 is a top plan view of the first preferred embodiment guitar pick of FIG. 1;

FIG. 3 is a side elevational view of the first preferred embodiment guitar pick of FIG. 1;

FIG. 4 is a bottom plan view of the first preferred embodiment guitar pick of FIG. 1;

FIG. 5A is a perspective view of a first alternative embodiment of the guitar pick according to the present invention;

FIG. 5B is a perspective view of a second alternative embodiment of the guitar pick according to the present invention;

FIG. 6 is a top plan view of the second preferred embodiment guitar pick of FIG. 5;

FIG. 7 is a top plan view of the method of forming a pick for playing a non-bowed stringed instrument, such as a guitar, according to the present invention, showing the graphic images and the shape and size of a pick, formed on a thin flat backing;

FIG. 8 is a top plan view of one piece of the thin flat backing of FIG. 7, cut out to the shape and size of a guitar pick;

FIG. 9 is a top plan view of a plurality of the thin flat backings of FIG. 8, placed in a curing tray;

FIG. 10 is a perspective view of one of the plurality of the thin flat backings of FIG. 8, and showing a resin mixture being introduced onto the front face of the thin flat backing, to form a similar shape guitar pick;

FIG. 11 is a side elevational view of the guitar pick of FIG. 10, with the thin flat backing being removed; and,

FIG. 12 is a side elevational view of the guitar pick of FIG. 11, being sanded.

### DETAILED DESCRIPTION OF THE PREFERRED AND ALTERNATIVE EMBODIMENTS

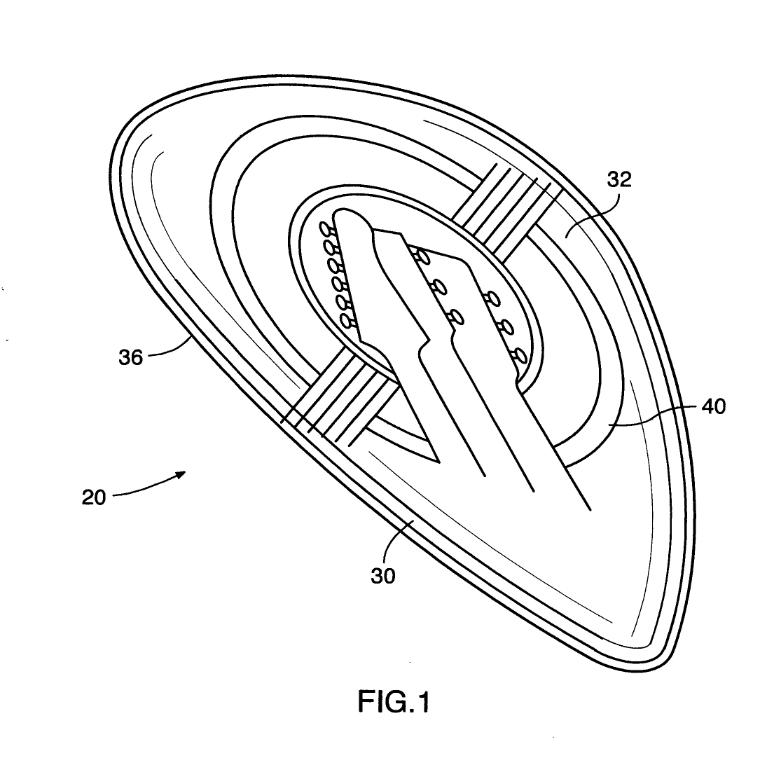

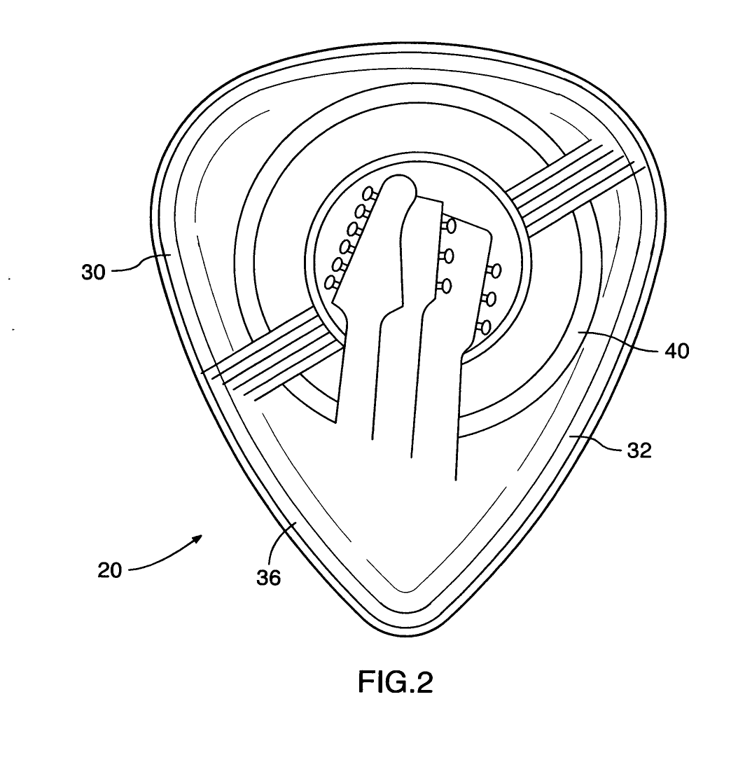

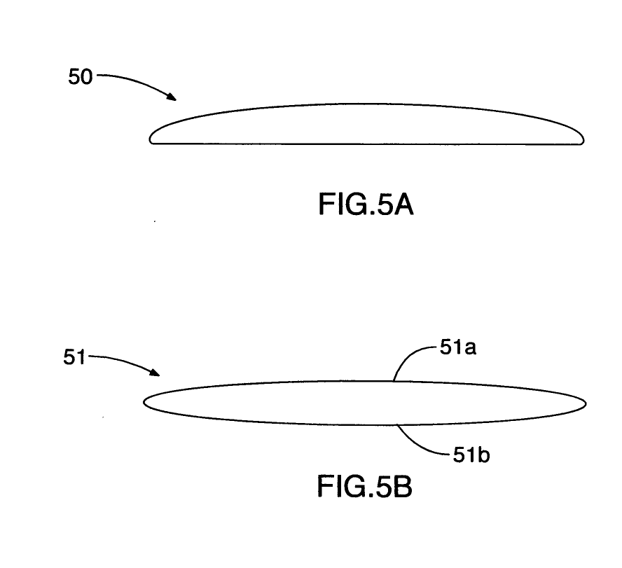

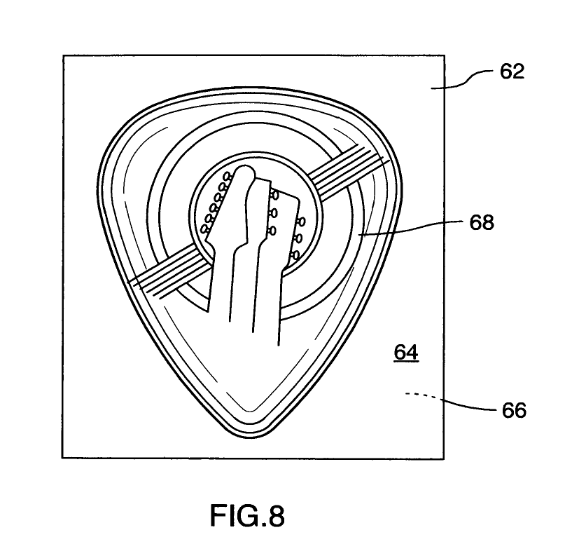

Referring to FIGS. 1 through 12 of the drawings, it will be noted that FIGS. 1 through 4 illustrate a first preferred embodiment of the guitar pick of the present invention, FIG. 5A illustrates a first alternative embodiment of the guitar pick of the present invention, FIG. 5B illustrates a second alternative embodiment of the guitar pick of the present invention, Figure illustrates a second preferred embodiment of the guitar pick of the present invention, and FIGS. 7 through 12 illustrate a method of forming a pick for playing a non-bowed stringed instrument, such as a guitar, according to the present invention.

Reference will now be made to FIGS. 1 through 5B, which show a first preferred embodiment of the guitar pick of the present invention, as indicated by general reference numeral 20, a first alternative embodiment of the guitar pick of the present invention, as indicated by general reference numeral 50, and a second alternative embodiment of the guitar pick of the present invention, as indicated by general reference numeral 51. The guitar pick 20 is for playing a non-bowed stringed instrument, such as a guitar. The first preferred embodiment guitar pick 20 comprises a main body 30 having a front surface 32 and a back surface 34, and a peripheral edge 36 adjoining the front surface 32 and a back surface 34, as do the alternative embodiment guitar picks 50 and 51 (FIGS. 5A and 5B). The peripheral edge 36 can be any suitable shape for a guitar pick 20. At least a substantial portion of the main body 30 comprises a doming mixture, which is preferably a resin mixture. Preferably at least a substantial portion of the main body 30 comprises epoxy resin. The preferred and alternative embodiment guitar picks 20, 50 and 51 according to the present invention are made from an epoxy, polyurethane or other liquid resin mixtures and materials which harden to predetermined customizable shapes.

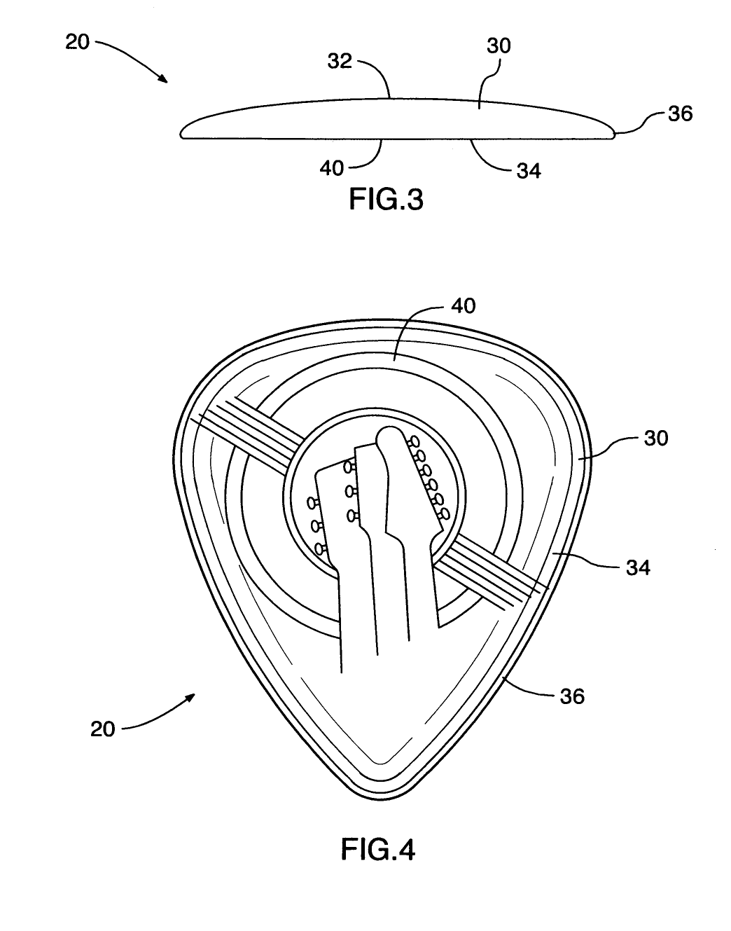

As can be readily seen in the figures, especially in FIG. 3, the front surface 32 of the main body 30 is substantially dome shaped. This dome shape results from the manufacturing operation, as will discussed subsequently. Further, the back surface 34 of the main body 30 is substantially flat. The peripheral edge 36 adjoining the front surface 32 and the back surface 34 has a slight vertex at initial formation, as can be seen in FIG. 5, which is an alternative embodiment of the present invention. This slight vertex can be removed, if desired, by careful sanding or grinding, if desired, to achieve the form of pick 20 as shown in FIGS. 1 through 4. This pick 20 is, in essence, domed on both the front surface 32 and the back surface 34.

As can readily be seen in FIGS. 1, 2 and 4, the back surface 34 of the main body 30 includes a graphic image 40. This graphic might be of a musical artist or band, or may be of a professional team, or might even be a company logo, or even any picture, as desired.

In the first preferred embodiment, as illustrated, the entire main body 30 of the guitar pick 20 comprises a resin mixture, preferably epoxy resin. The epoxy resin is substantially clear, or in other words transparent, such that the graphic image 40 on the back surface 34 of the main body 30 can be readily viewed from the front of the pick 20.

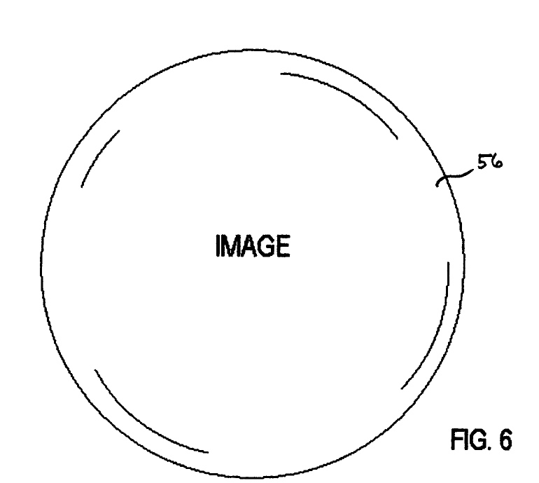

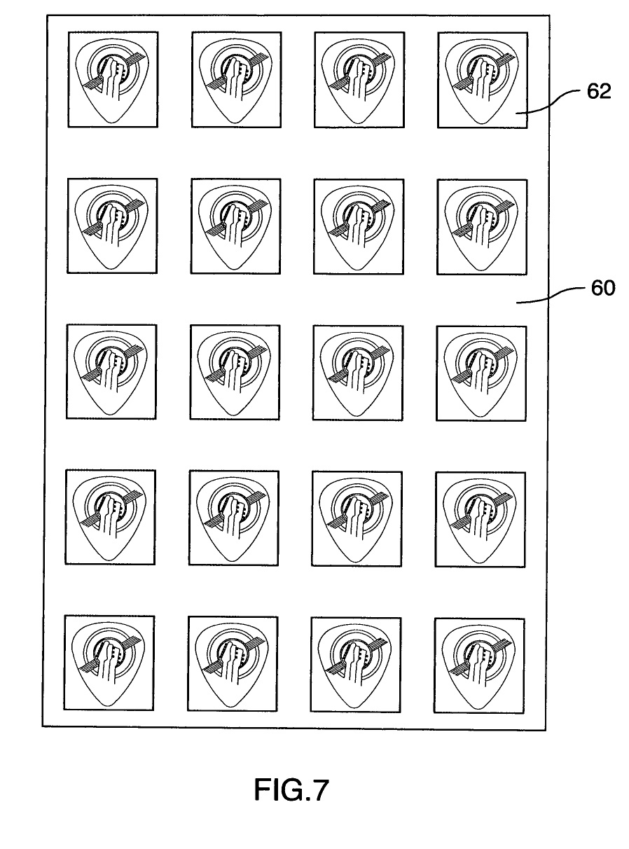

Reference will now be made to FIG. 6, which shows a second preferred embodiment of the guitar pick 56 according to the present invention. The second preferred embodiment guitar pick 56 is similar to the first preferred embodiment guitar pick 20, except that it is round, not the more common triangular shape.

Reference will now be made to FIGS. 7 to 12, which show a method of forming a pick 20 for playing a non-bowed stringed instrument, such as a guitar. The method comprising the following steps that will now be described in detail.

First, a thin flat backing 62 is provided. As illustrated in FIG. 7, each thin flat backing 62 is cut from a sheet of print media 60. Only one of the twenty thin flat backings shown in FIG. 7 is indicated by reference numeral 62 for ease of illustration. Preferably, the thin flat backing 62, shown separately in FIG. 8, has a front face 64 and a back face 66, and is made from a water resistant material, such as vinyl or waterproof paper. The thin flat backing 62 preferably has a special coating on it to absorb and retain ink that forms a graphic image 68 that will be printed onto the main body 30 of the guitar pick 20. Accordingly, the step of providing a thin flat backing 62 for the pick 20 comprises printing the graphic image 68 onto print media 60.

The graphic image 68 on thin flat backing 62 might be related to music, such as a musical artist or band, or might be a professional team, a company logo, and so on, as desired.

Preferably, the graphic image 68 is made from a releasing ink, such that the graphic image 68 transfers to the bottom surface the hardened resin mixture pick 20.

Next, the thin flat backing 62 is cut into a pre-determined shape. More specifically, the print media 60 as shown in FIG. 7 is cut into a number of predetermined shapes, such as the shape shown in FIG. 8.

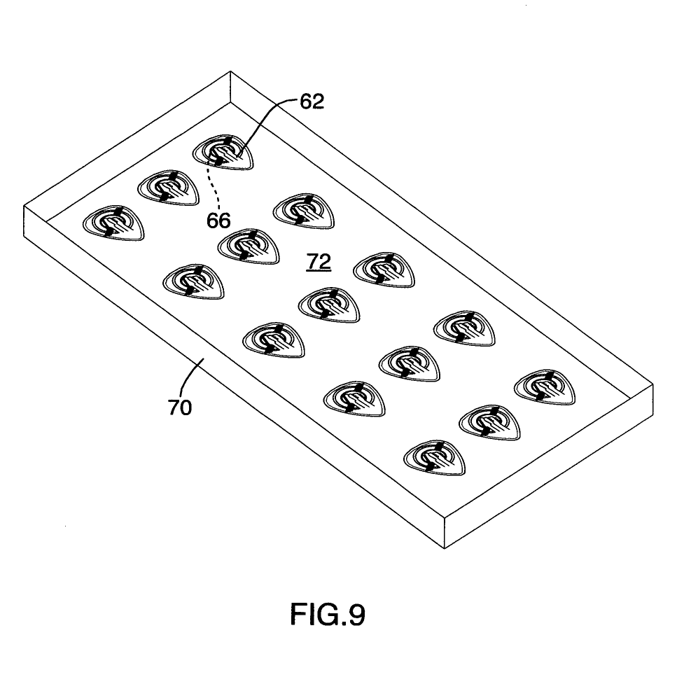

As can be seen in FIG. 9, the thin flat backings 62 are placed onto a curing tray 70 with the back face 66 of each thin flat backing 62 against the curing tray 70 and the front face 64 of each thin flat backing 62 facing generally upwardly. Preferably, the curing tray 70 comprises an adhesive curing tray 70, or in other words has a mildly adhesive upwardly facing receiving surface 72 that keeps the thin flat backings 62 in place absolutely flat on the curing tray 70.

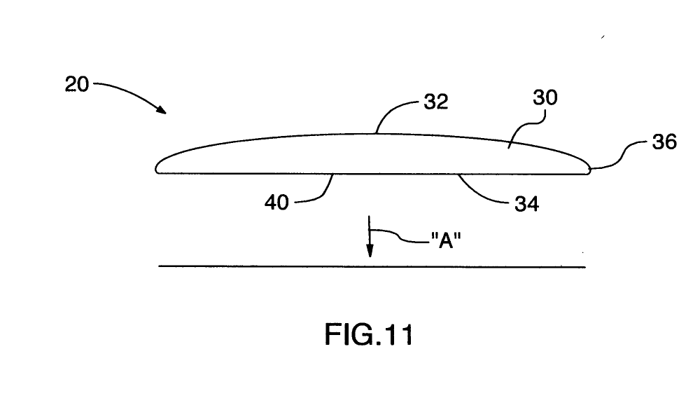

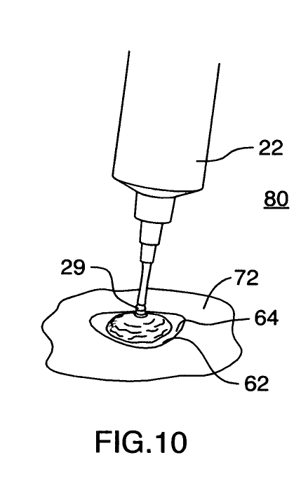

Next, as can be seen in FIG. 10, a doming mixture, which is preferable, a resin mixture, is carefully introduced onto the front face 64 of the thin flat backing 62. The resin mixture, which is preferably a liquid epoxy resin, as indicated by the reference numeral 29, is reasonably viscous, and accordingly flows slowly to the outer edge of the thin flat backing 62. Surface tension causes of the liquid epoxy resin 29, which of course is the doming mixture, to stop at the outer edge of the thin flat backing 62, thus defining and forming the main body 30 of the guitar pick 20. Accordingly, the main body 30 of the guitar pick 20 will have the same shape as the thin flat backing 62. The doming material can also be polyurethane, or any other suitable material.

Preferably, but not necessarily, the step of introducing the doming mixture 29 onto the thin flat backing 62 is performed with a syringe device 22. Other suitable methods they also be used. Also, the step of introducing the doming mixture 29 onto the thin flat backing 62 is performed in an environmentally controlled area 80, in order to control temperature, dust and humidity.

The resin mixture 29 is then permitted to cure, thus forming a hardened resin mixture guitar pick 20 comprising the main body 30 with its front surface 32, back surface 34, and peripheral edge 36. Next, as shown in FIG. 11, the thin flat backing 62 is separated from the hardened resin mixture guitar pick 20, as indicated by arrow “A”. The ink that forms the graphic image 68 on the thin flat backing 62 transfers to the back surface 34 of the main body 30 of the guitar pick 20 as a graphic image 40. The graphic image 40 can be viewed from above the domed top surface of the guitar pick 20, thus providing a highly aesthetic quality to the guitar pick 20.

Utilizing this new manufacturing method, photo quality images may be introduced onto a guitar pick 20 by using a specialized print media 69 which allows the transfer of photo quality images onto the print media 69, and then subsequently completely releases and transfers the image on to the underside of the main body 30 of the guitar pick 20, when the doming mixture is applied to this specialized media.

At this point, the guitar pick 20 is in a finished form, as is shown in FIG. 11, and also in FIG. 5A, and is therefore usable without further modification. It has been found that the texture and flexibility of the epoxy resin provide a better grip and comfort to the guitarist. If desired, the present invention may further comprise the step of grinding or sanding the main body 30, to form the first preferred embodiment guitar pick 20, as shown in FIG. 3 and in FIG. 12, through the use of an appropriate abrasive element 90. The application of slight mechanical sanding or grinding to the main body 30 of the guitar pick 20 can also be performed in order to eliminate imperfections. Further, the application of slight mechanical sanding or grinding to the main body 30 can be used to form a second alternative embodiment guitar pick 51, as shown in FIG. 5B, where the back surface 51b is slightly reformed to be domed shaped, as is the front surface 51a. The second alternative embodiment guitar pick 51 is therefore substantially symmetrical from front to back.

By using our new manufacturing technique with specialized print media 69 and specialized cutting equipment, small custom shape runs can be prepared using a printer/media cutting device (not specifically shown) or plotter to determine the specific size and shape of the guitar pick 20 without use of expensive dyes or production molds. The doming mixture is poured on to the precut media shape and hardens to the exact size and shape of the precut media.

As can be understood from the above description and from the accompanying drawings, the present invention provides guitar picks made from epoxy resin, which guitar picks 20 and 50 conform to the finger position of the guitarist, are comfortable to use, are other than triangularly shaped, wherein it is not cost prohibitive to produce small production runs of custom shape guitar picks, have full color photographic quality pictures on them, and can be completely transparent, provide a softer and superior tone not available with conventionally manufactured picks and only comparable to picks made with tortoise shells picks, which are presently considered illegal for tortoise preservation reasons, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the guitar picks 20 and 50 of the present invention without departing from the spirit and scope of the accompanying claims.

I claim:

1. A pick for playing a non-bowed stringed instrument, such as a guitar, said guitar pick comprising:
a main body having a front surface and a back surface, and a peripheral edge adjoining said front surface and a back surface;
wherein at least a substantial portion of said main body comprises a doming mixture.

2. The guitar pick of claim 1, wherein the entire main body comprises a doming mixture.

3. The guitar pick of claim 1, wherein said doming mixture comprises a resin mixture.

4. The guitar pick of claim 1, wherein said doming mixture comprises an epoxy resin.

5. The guitar pick of claim 1, wherein said front surface of said main body is substantially dome shaped.

6. The guitar pick of claim 1, wherein said back surface of said main body is substantially flat.

7. The guitar pick of claim 1, wherein said doming mixture is substantially clear.

8. The guitar pick of claim 7, wherein said back surface of said main body includes a graphic image.

9. A method of forming a pick for playing a non-bowed stringed instrument, such as a guitar, said method comprising the steps of:
providing a thin flat backing having a front face and a back face;
placing the thin flat backing onto a curing tray with said back face against the curing tray and said font face facing generally upwardly;
introducing a doming mixture onto said front face of said thin flat backing;
permitting said doming mixture to cure, thus forming a hardened pick having a bottom surface and a domed top surface; and,
separating the thin flat backing from the hardened pick.

10. The guitar pick of claim 9, wherein said doming mixture comprises a resin mixture.

11. The guitar pick of claim 9, wherein said doming mixture comprises an epoxy resin.

12. The guitar pick of claim 9, wherein said front surface of said main body is substantially dome shaped.

13. The method of claim 9, wherein said thin flat backing includes a graphic image.

14. The method of claim 13, wherein said graphic image is made from a releasing ink, such that said graphic image transfers to the bottom surface said hardened pick.

15. The method of claim 9, wherein the step of introducing said doming mixture onto said thin flat backing is performed with a syringe device.

16. The method of claim 9, wherein the step of introducing said doming mixture onto said thin flat backing is performed in an environmentally controlled area.

17. The method of claim 9, further comprising the step of grinding or sanding said main body.

18. The method of claim 9, wherein said guitar pick is in a finished form and therefore usable without further modification.

19. The method of claim 9, wherein said curing tray comprises an adhesive curing tray.

20. The method of claim 9, wherein the step of providing a thin flat backing for said pick comprises printing a graphic image onto said front surface of said thin flat backing, and cutting the thin flat backing into a pre-determined shape.
